(19) United States
(12) Patent Application Publication
(10) Pub. No.: US 2004/0047340 A1
(43) Pub. Date: Mar. 11, 2004

(54) Method for address conversion in packet networks, control element and address converter for communication networks

(76) Inventors: Hanspeter Ruckstuhl, Wolfratshausen (DE); Jean-Marie Stupka, Germering (DE)

Correspondence Address: Kevin R. Spivak, Morrison & Foerster LLP, Suite 300, 1650 Tysons Boulevard, McLean, VA, 22102, US

(21) Appl. No.: 10/405,082

(22) Filed: Apr. 2, 2003

Related U.S. Application Data
(60) Provisional application No. 60/396,000, filed on Jul. 16, 2002.
(60) Provisional application No. 60/396,007, filed on Jul. 16, 2002.

(51) Int. Cl. H04L 12/66; H04L 12/28; H04L 12/56

(52) U.S. Cl. 370/352; 370/401; 370/392

(57) ABSTRACT

A method and a control element are provided for address conversion for a user data connection controlled via a signaling connection between a first communication network and a second communication network. A connection request is sent from a first network element and communicates with a second network element accessible via the second communication network. An address conversion relationship is then determined between the first and second communication networks valid for the user data connection of the first network element. Also provided is an advanced method for addressing specific problems in address conversion for multi-channel user connections. A specific fourth network element, or address converter, is provided that allows for address conversion in the multi-channel case.

### CLAIM FOR PRIORITY

This application claims priority to Provisional Application Nos. 60/396,000 and 60/396,007 which were filed in the German language on Jul. 16, 2002.

### TECHNICAL FIELD OF THE INVENTION

The present invention relates to a system and method for address conversion in a network, and in particular, to address conversion of a user data connection controlled via a signaling connection between a first communication network and a second communication network.

### BACKGROUND OF THE INVENTION

Modern packet network protocols such as the Internet Protocol IP use the same addresses for addressing terminals and routing data packets between source and destination. The addresses in the case of the Internet Protocol are made up from the IP address and the UDP/TCP port number (UDP=User Datagram Protocol, TCP=Transmission Control Protocol). This facilitates global communication and accessibility but requires a very large number of global addresses, i.e. worldwide unique addresses.

In practice, methods are often implemented to reduce the number of global addresses required for worldwide communication. Local networks are created with private addresses, which are only locally unique and only locally valid. In the case of IP networks based on IP version 4 (IPv4), address domains for private networks are defined in IETF RFC 1918. A further IETF RFC is at the preparation stage and is currently available in draft form with the title “Special-Use IPv4 Addresses”. The file name of the current draft version 3 is “draft-iana-special-ipv4-03.txt”. This draft version 3 is available on the internet from the IETF and elsewhere.

When private or local networks are used, cross-network communication requires the conversion of local addresses to other local or global addresses. This method is referred to below as address conversion. In practice address conversion is also used to protect networks against unauthorized access from outside.

Address conversion is frequently used in the now widespread IP networks. In this specific environment, i.e. with the interconnection of IP networks, it is referred to as Network Address Translation NAT or Network Port Address Translation NPAT and it is defined in IETF RFC 1631. NAT or NPAT is tried and tested for data communication between terminals and servers.

Modern packet networks are suitable both for real-time communication, such as voice, and for the transfer of data without real-time requirements. Real-time communication in packet networks generally functions according to the principle of separation of connection and user channel control. Therefore, unlike in conventional telephone networks, different network elements are used for connection control and user channel control, at a logical level at least. Connection control is managed by specialist control elements, which communicate with terminals, media gateways, access concentrators, multimedia servers and other network elements and of course also with each other.

For voice and multimedia communication applications these specialist control elements are often also referred to as soft switches. Depending on the environment and application, soft switches support the widest range of procedures and protocols for connection control, e.g. Session Initiation Protocol SIP, Bearer Independent Call Control BICC, ITU-T H.323, ITU-T H.248 or Media Gateway Control Protocol MGCP.

All these methods for controlling real-time communication have in common the fact that the addresses of the communication partners involved are exchanged via the connection control protocol. If address conversion is implemented, the addresses of the terminals involved signaled via connection control protocol and the actual addresses required to address the user channel data are different. This means that real-time communication does not function when address conversion is implemented.

It is possible to circumvent the resulting problem by using static address conversion in the network element controlling the connection, e.g. SoftSwitch, and in the element controlling the user channel, e.g. the NAT/NPAT router. However this procedure involves a very high administrative cost and is therefore not practical. In the first place it has to be ensured that the address conversion tables in the network element controlling the connection and in the network element controlling the user channel are consistently updated. Secondly the address conversion tables have to be modified whenever the configuration changes, i.e. for example when a single VoIP Client is added.

### SUMMARY OF THE INVENTION

The present invention relates to a method and a network element, which allow real-time communication with the use of address conversion. The present invention also relates to a method and a network element, which allow real-time communication in IP networks with the use of NAT or NPAT.

The present invention also provides a method for address conversion in packet networks and an address converter for dynamic address conversion, if more than one user data channel is used to transfer the user data, as one address relationship can be forwarded in the signaling messages.

According to one embodiment of the present invention, there is a method for address conversion for a user data connection NV controlled via a signaling connection SV between a first communication network N1, which has addresses which are valid within the first network N1, and a second communication network N2, in which a connection request is transferred from a first network element NE1 located in the first network N1, to which a first address A1 is assigned, with the connection request having the purpose of communication with a second network element NE2, to which a second address A2 is assigned and which can be accessed via the second network N2, and the connection request being routed first to a control element S in the first network N1 located at a point of transition between the first and second networks, with the control element S having both a third address A3 in the first network N1 and a fourth address A4 in the second network N2, according to which a message with the first address A1 as the source address and the fourth address A4 as the destination address is sent by the control element S via a fourth network element AU, which switches user data, to determine a valid address conversion relationship A1<->A1′ between the first and second networks for the user data connection NV of the first network element NE1 routed via the fourth network element AU.

According to one aspect of the invention, a control element S is also provided for communication networks N1, N2, which is located at a point of transition between a first and a second communication network, with the first network N1 having addresses which are valid within the first network N1 and with the control element S having both a third address A3 in the first network N1 and a fourth address A4 in the second network N2,

with devices to receive a connection request from a first network element NE1 located in the first network N1, with a first address A1, with the connection request having the purpose of communication with a second network element NE2 accessible via the second network N2, to which a second address A2 is assigned,

with devices for sending a message with the first address A1 as the source address and the fourth address A4 as the destination address via a fourth network element AU, which switches user data, to determine a valid address relationship A1<->A1′ between the first and second networks for a user data connection NV of the first network element routed via the fourth network element AU.

According to another embodiment of the invention, there is a method for address conversion for a user data connection controlled via a signaling connection, in which the user data connection is made up of a number of data channels (i.e. more than one data channel), according to which a base address conversion is determined for a first data channel between the first and a second communication network for a network element requesting a connection, which is assigned to a first communication network. All other data channels are formed by a predefined algorithm from the base address conversion and modified by an address converter. This method is particularly useful for dynamic address translation if multiple user channels are required for one user connection of course, this method can be advantageously combined with the above method and control element.

According to one aspect of the present invention, an address converter for communication networks is provided, which is located at a point of transition between a first and a second communication network, with the first network having addresses which are valid within the first network,

with devices to receive a message, which explicitly or implicitly contains information about a number of data channels to be reserved,

with devices to determine a base address conversion and further address conversion based on this base address conversion, with the total number of address conversion being based on the number of data channels to be reserved.

This address converter is particularly useful for dynamic address translation if multiple user channels are required for one user connection. Of course, the address converter can be advantageously combined with any of the above aspects of the invention.

One important advantage of the invention is that new sender addresses and destination addresses, to be used after address conversion, can be reliably modified and determined when switching networks or crossing network boundaries.

The invention is particularly suitable for IP networks and for use in conjunction with real-time communication in IP networks with separate connection and user channel control.

The invention also has the following advantages:

No special equipment or interfaces are required. Any messages or data packets can be used to determine and modify address conversion.

The invention can be used with both static and dynamic address conversion or a combination of the two methods.

The invention can be deployed in current IP networks, which use NAT/NPAT, without having to introduce additional network elements.

The base conversion aspect of the invention functions with conventional address converters, in the case of IP networks therefore with conventional NAT/NPAT routers, which do not have interfaces for determining and modifying address conversion. The advanced conversion aspect of the invention for multiple user channels in a dynamic environment can easily be implemented, for example by way software upgrade, as separate new hardware is not required. Further, the advanced conversion aspect does not require modifications to connection control and the network elements controlling the connection.

When static address conversion is used, administrative costs are reduced drastically, as the relevant data only has to be managed in the network element switching the user data, with the invention enabling the static configuration stored in the address converter to be determined by a control element.

The inventive address converter does not require a separate connection or interface to the network element controlling the connection.

### BRIEF DESCRIPTION OF THE DRAWINGS

Embodiments of the invention are described in more detail below with reference to the drawings, in which:

FIG. 1 shows the connection of two networks by means of an address converter and a control element. FIG. 2 shows a typical network constellation for a real-time communication connection between two terminals via a packet network with the associated processes for address signaling.

### DETAILED DESCRIPTION OF THE INVENTION

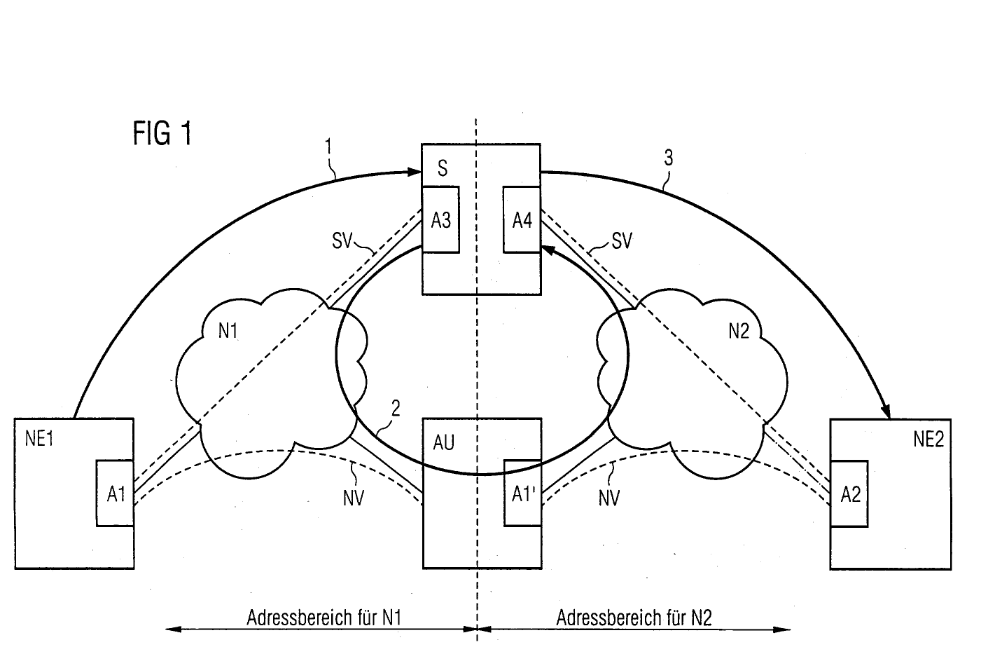

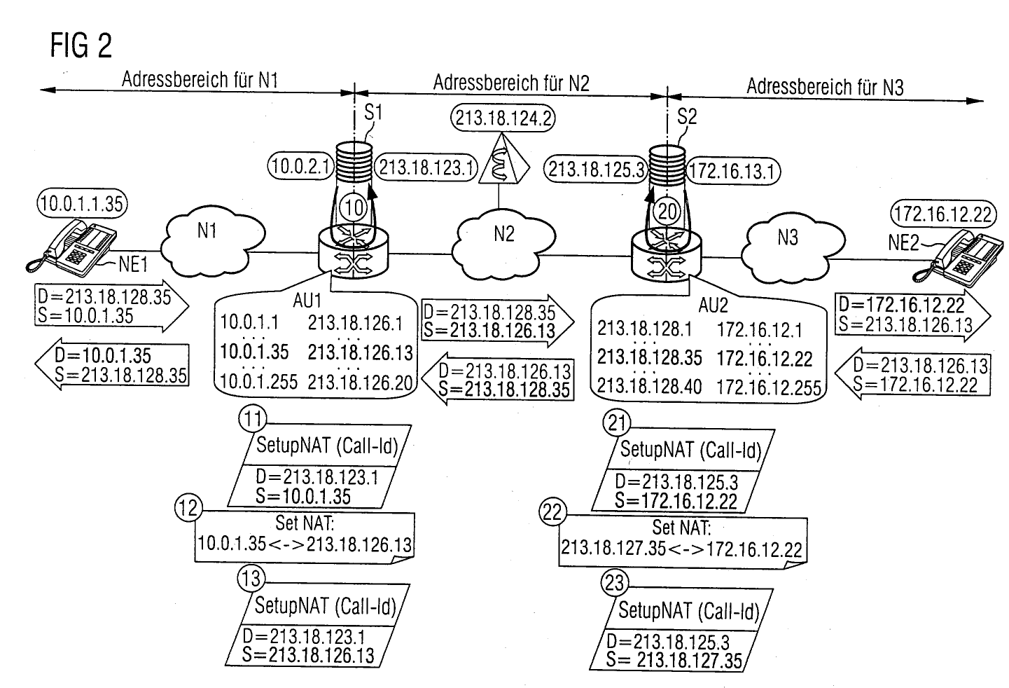

FIG. 1 shows a first network element NE1 and a second network element NE2. These network elements may be terminals, media gateways, access concentrators, multimedia servers or any other network elements in an IP network. In the case of terminals, these may be voice-over-IP VoIP terminals or terminals for IP-based video conferences.

The first network element NE1 has a first network address A1 and the second network element NE2 has a second network address A2. For the preferred embodiment, addresses A1 and A2 are IP addresses. To simplify the diagram, only one address was shown for each of the network elements NE1 and NE2. It is however possible and in many cases necessary for the network elements NE1 and NE2 to have more than one address. This is guaranteed in IP networks by the port numbers of the UDP and TCP protocols. A full TCP/UDP address therefore always comprises the IP address and port number.

The first network element NE1 is connected to a first communication network N1 (hereafter abbreviated to first network N1) and is therefore an element or component of the first network N1. Also connected to the first network N1 is a control element S, which is used to control the connection, and an address converter AU, the function of which will be examined in more detail below.

The second network element NE2 is accessible via a second communication network N2 (hereafter abbreviated to second network N2). It is of minor significance to the present invention whether it is linked indirectly to the second network N2, i.e. via further networks (not shown) or directly. The connection between the second network N2 and the second network element NE2 is therefore shown with a mixed broken line, to indicate that this connection may be made via further interim networks. It is only important for the description of the present invention that the two networks N1 and N2 are different. “Different” here means that an element in the network N1 cannot be accessed directly from the second network N2 except via the address converter AU and vice versa. Possible reasons for this and standard solutions for IP networks have already been explained above. An address domain or address field is assigned to each of the two networks N1, N2. The resulting two address domains are shown by the corresponding arrows. Separation of the two address domains at the boundary of the two networks N1, N2 is shown by a broken line.

Further components of the second network N2 or connected to it are the control element S and the address converter AU.

The address converter AU is used, as already stated, to convert addresses between the two networks N1 and N2. It is assumed below, without restriction to general applicability, that the first network N1 is a non-public or private network and that the second network N2 is a public network. The address converter AU has a series or a pool of addresses in the public network N2, which can be assigned dynamically or statically to elements in the non-public network N1. A fifth address A1′, which is assigned in the address converter to the first address A1 of the first network element NE1, is shown as an example. Messages from the public to the non-public network are then sent to the address A1′ in the address converter, which uses a table for example to determine the assignment A1<->A1′ and routes the messages to the first address A1.

FIG. 1 also shows a control connection SV between the first network element NE1 and the control element S and between the control element S and the second network element NE2 with a broken line. A user data connection NV is also shown as a broken line, with the user data connection existing between the first network element NE1 and the address converter AU, as well as the address converter AU and the second network element NE2.

The control element S has at least a third address A3 from the address domain of the first network N1 and at least a fourth address A4 from the address domain of the second network N2, in order to be able to control incoming or outgoing connections in respect of the first network N1. The control element S also contains tables or other assignment mechanisms, in order to determine the network address of the network element addressed by the destination address from the address domain of the first network element N1 for incoming connections in respect of the first network N1 from a destination address compatible with the respective switching protocol. The control element S also contains tables or other assignment mechanisms, in order to determine the network address of the associated network element in each instance or the network address of a forwarding network element, for example a further control element, for outward connections in respect of the first network N1 or connections to be switched within the network N1 from a destination address compatible with the respective switching protocol. There is also an internal communication path for the control element S between a first interface of the control element S with the first network N1 and a second interface of the control element S with the second network N2.

A problem arises, when a connection is initiated outwards from the first network element NE1. The first address A1 of the first network element NE1 is input in a corresponding signaling message, which is exchanged via the signaling connection. This first address A1 here represents the user channel address. In the preferred embodiment this can be an IP address with a corresponding TCP/UDP port. The act of sending the signaling message is shown as “1” in FIG. 1. It is irrelevant for the present invention, whether the signaling connection to the control element first has to be set up or whether this exists permanently.

When the signaling message is received by the control element S and the control element S detects a destination outside the first network N1, it is then the case that a source address A1 invalid outside the network N1 designates the network element NE1 requesting the connection. To continue to set up the connection, instead of the first address A1, its “representative address”, which is valid in the second network N2, the fifth address A1′, is input in the signaling message generated and forwarded by the control element S. This address conversion relationship A1<->A1′ is however not known at the control element S. In the case of dynamic address conversion, in which the “representative address” A1′ is not assigned until a connection is requested via the address converter AU by the first network element A1, for example on establishment of the user data connection NV, the address conversion relationship is not known at the time when the control element S has to forward the signaling message in order first to forward the signaling connection SV to the actual destination.

This problem is resolved according to the invention by the process marked “2” in FIG. 1. For this, a message is sent from a first interface of the control element S in the first network N1, to which the third address A3 is assigned, to a second interface of the control element in the second network N2, to which the fourth address A4 is assigned. This message however does not include the third address A3 as the sender ID or source ID but the address of the network element requesting the connection, in this case the first address A1. The message can be any valid message. No further modification of the message is necessary. The address converter interprets the message received with source ID=A1 and destination ID=A4 as a message from the first network element NE1 and processes it in accordance with the known mechanisms for address converter AU. In the case of static address conversion, the address converter AU routes the message on to the second interface of the control element S using the address conversion relationship A1<->A1′ hitherto only known in the address converter AU, with the address converter AU forwarding the message with source ID=A1′ and destination ID=A4. In the case of dynamic address conversion the address converter AU determines an appropriate “representative address” A1′ according to a well-known method and records this address conversion relationship A1<->A1′, which is only valid from this point onward, in a table or a different assignment memory and then routes the message on with source ID=A1′ and destination ID=A4.

The “representative address” assigned to the first address A1 of the first network element NE1, the fifth address A1′, can be derived in the control element S from the message received via the second interface. This fifth address A1′ is representative of the first network element NE1 in the second network N2, i.e. items routed within the second network N2 to the fifth address A1′ are received by the address converter AU and converted to the first address A1 for forwarding to the first network element NE1 in the first network N1. The process with which the signaling message is routed forwards, i.e. to its destination, is shown as “3” in FIG. 1. The “representative address” A1′ for the first network element NE1 valid in the second network N2 is input into this signaling message by the control element S, so that the user data connection NV can be established end to end, in other words between the first network element NE1 and the second network element NE2.

In the reverse direction, i.e. for messages controlling the connection, received by the control element S from the second network N2 with a destination within the first network N1, the user channel address received from the second network N2 is not changed, as the signaled user channel address is a global address, i.e. an address from the address domain for the second network N2.

A typical network situation is explained below with reference to FIG. 2, in which the second network element NE2 forms part of a third communication network N3. Networks N1 and N2 are linked as shown in FIG. 1 via a first address converter AU1 and a first control element S1. Networks N2 and N3 are linked in a similar way via a second address converter AU2 and a second control element S2. The address domains of networks N1 and N3 are not directly accessible from the second network N2 but only by means of address conversion in the address converters AU1 and AU2.

For the diagram in FIG. 2, to describe the preferred embodiment more clearly, direct IP addresses are used instead of the symbolic addresses A1, A2, A3, A4, A1′ used up to now. However this does not mean that the invention is restricted to IP addresses. The use of other address forms or address formats will be immediately clear to the person skilled in the art from FIG. 2 in conjunction with the descriptions relating to FIG. 1.

The IP address field 10.x.x.x was selected as an example of the address domain of the first network N1 and according to the frequently used IETF RFC 1918 this defines a private class A IP network. The IP address field 172.16.x.x was selected as an example of the address domain of the third network N3 and according to the frequently used IETF RFC 1918 this defines a private class B IP network. As further progress is made with worldwide standardization these address fields or their classifications may change. It is only important to the description of the embodiment that the addresses of the networks N1 and N3 are not visible from the second network N2 and that address conversion is necessary to access destinations in networks N1 and N3.

Although IPv4 addresses are used to describe the embodiment in conjunction with FIG. 2 and the invention is particularly suitable for IPv4 networks, as the restricted availability of worldwide unique IPv4 addresses means that private networks have to be created, which then require address converters for external communication, the invention can also be used for networks based on IPv6, even if IPv6 means there is no need for address conversion due to restricted address fields. As mentioned above, other considerations, e.g. security interests, may require the demarcation of an address field from the public address field.

The following table shows the IP addresses of the individual components selected for FIG. 2. Addresses in quotation marks designate “representative addresses”, which do not occur with dynamic address conversion until the connection is being set up.

| | Address in the | Address in the | Address in the |
|---|---|---|---|
| Component | first network N1 | second network N2 | third network N3 |
| NE1 | 10.0.1.35 | “213.18.126.13” | — |
| NE2 | — | “213.18.128.35” | 172.16.12.22 |
| S1 | 10.0.2.1 | 213.18.123.1 | — |
| S2 | — | 213.18.125.3 | 172.16.13.1 |

The network elements NE1 and NE2, shown for example in FIG. 2 as VoIP terminals, also have a symbolic or logical address (not shown) in addition to the assigned IP addresses. This logical address can be in the form of a conventional telephone number. To set up a connection from the first network element NE1 to the second network element NE2, a user dials this telephone number at the first network element NE1. This results in the processes described below. To simplify the diagram in FIG. 2 and the description below, the following abbreviations have been selected:

D=Destination Address

S=Source Address

A connection request is sent from the first network element NE1 to the first control element S1 with the logical address of the second network element NE2. Processing of the connection request in the first control element S1 is well known in the prior art and is not described in more detail here. The logical address of the second network element NE2 is used to determine that the second network element NE2 can be accessed via the second network N2. In order to be able to forward the connection request to the competent second control element S2, the second network N2 address representing the first network element NE1 is determined by means of the process 10, comprising stages 11, 12, 13.

In stage 11 the first control element S1 sends a message, designated here as “SetupNAT (Call-Id)” to the first address converter AU1, which is preferably a NAT router. This message is marked D=213.18.123.1, S=10.0.1.35, i.e. the source address of the first network element NE1.

In stage 12 the first address converter AU1 generates the address conversion relationship 10.0.1.35<->213.18.126.13 i.e. the global address 213.18.126.13 represents the first network element NE1. This relationship is recorded in a corresponding table in the first address converter AU1, in which other address conversion relationships are also stored. Alternatively in the case of static address conversion the address conversion relationship 10.0.1.35<->213.18.126.13 is already defined beforehand.

In stage 13 the first address converter AU1 forwards the message “SetupNAT (Call-Id)” to D=213.18.123.1 and sets the “representative address” S=213.18.126.13 as the source address. A call ID or connection ID in the “SetupNAT (Call-Id)” message is used to assign the “representative address” received to the connection requested by the first network element NE1.

The signaling connection (not shown) is used to forward the connection request by means of the logical address of the second network element NE2 via further elements, for example shown by an element with the address 213.18.124.2, to the second control element S2 and from there to the second network element NE2.

The connection request is confirmed in the reverse signaling path. For this the second network element sends a confirmation message to the second control element S2. In order to be able to forward the confirmation to the competent first control element S1, the process 20 comprising stages 21, 22, 23 is used to determine the address representing the second network element in the second network N2. At the same time the “representative address” 213.18.126.13 of the first network element NE1 contained in the connection request is recorded for the user data connection to be established. As the “representative address” 213.18.126.13 is a global address, data communication can already take place at this time from the second network element NE2 to the first network element NE1 but not yet the other way round.

As an alternative to the option described below of making the “representative address” of the second network element NE2 known to the first network element NE1, there is another option of sending any user message from the second network element NE2 to the first network element NE1 so that the “representative address” of the second network element NE2 is automatically made known, as the message has to be routed through the second address converter and the address conversion is therefore defined or determined.

In stage 21 the second control element S2 sends a message designated here as “SetupNAT (Call-Id)” to the second address converter AU2, which is preferably a NAT router. This message is marked D=213.18.125.3, S=172.16.12.22, i.e. the source address of the second network element NE2.

In stage 22 the second address converter AU2 generates the address conversion relationship 172.16.12.22<->213.18.128.35, i.e. the global address 213.18.128.35 thereby represents the second network element NE2. This relationship is recorded in a corresponding table in the second address converter AU2, in which other address conversion relationships are also stored. Alternatively in the case of static address conversion the address conversion relationship 172.16.12.22<->213.18.128.35 has already been defined beforehand.

In stage 23 the second address converter AU2 forwards the “SetupNAT (Call-Id)” message to D=213.18.125.3 and sets the “representative address” S=213.18.128.35 as the source address. A call ID or connection ID contained in the “SetupNAT (Call-Id)” message is used to assign the “representative address” received to the connection confirmed by the second network element NE2.

The signaling connection (not shown) is used to forward the connection confirmation to the first control element S1 using the logical address of the first network element NE1 and from there to the first network element NE1.

The “representative address” 213.18.128.35 of the second network element NE2 contained in the connection confirmation for the user data connection to be set up is recorded in the first network element NE1. As the “representative address” 213.18.128.35 is also a global address, bi-directional data communication can then take place between the first network element NE1 and the second network element NE1. The individual interim stages in the necessary address conversions are shown in FIG. 2 by arrows in the direction of flow of the messages containing the respective addresses.

In the following, the invention will be explained in more detail with respect to a user connection requiring multiple data channels, again using FIG. 1 as reference. That description will be laid out in terms of IP networks and in particular the transfer of data by means of Real Time Protocol RTP.

Information is taken from the initializing message, showing the number of channels required for the connection to be converted. This information may be included explicitly in one or more fields or parameters of the message or be revealed implicitly by the message protocol.

The source element or network element NE1 located in the first network N1 requests the connection NV to be connected to the second network element NE2, indirectly or directly accessible via the second network N2, the network elements having first and second IP addresses. In many cases it is necessary for the network elements to have more than one address. This is guaranteed in IP networks by the port numbers of the UDP and TCP protocols. A full TCP/UDP address therefore always comprises the IP address and port number. These TCP or UDP addresses are considered below.

The source element NE1 is connected to the first communication network N1 and is therefore an element or component of the first network N1. Also connected to the first network is a control element S, which is used for to control the connection and the (advanced) address converter AU according to an aspect of invention. The control element S and the address converter AU are also components of the second network and are connected to the second network. The control element and the address converters are located at the point of transition between the two networks.

There is a signaling connection between the source element and the control element as well as between the control element and the second network element. It is irrelevant for the present invention whether the signaling connection to the control element first has to be set up or whether it exists permanently.

A multi-channel user data connection is to be set up from the source element to the address converter and on to the second network element, i.e. a connection with a multitude of UDP or TCP ports. The general solution for that problem has been described above. With respect particularly to the multi-channel dynamic address conversion environment there is provided for the definition of a group of address conversions. These are preferably defined by an algorithm in the address converter, which should be defined network-wide for a specific protocol or a specific application.

For an RTP connection, which in principle is accompanied by an RTCP connection, the convention may for example be selected whereby the RTP connection is essentially assigned an even port number and the next odd port number is reserved for the associated RTCP connection. If this is known network-wide, transfer of the RTP base address (here: UDP address made up of IP address and port number) is sufficient to define the RTCP address (also a UDP address made up of IP address and port number) uniquely too.

This base address and the base address conversion derived from it can then be used by the control element to characterize the user connection channels to be assigned to the connection to be set up.

When routing the signaling message forward, i.e. to its destination, the “representative address” valid in the second network N2 for the source element Ne1 is input by the control element S, so that all the user data connection channels can be established end to end, i.e. between the source element NE1 and the second network element NE2.

In the reverse direction, i.e. for messages controlling the connection, received by the control element S from the second network N2 with a destination within the first network N1, the user channel address received from the second network N2 is not modified, as the signaled user channel address is a global address, i.e. an address from the address domain for the second network N2.

It is of course obvious that any algorithm can be selected to define the addresses of the other channels on the basis of the base address. The invention can be used for any number of data channels within the limitations of the address store.

Although the invention is particularly suitable for IP networks and use in conjunction with real-time communication in IP networks, the invention is not restricted to these applications. Any packet-based network, which operates with address conversion, can be improved by the present invention.

Particularly the address converter of the present invention can equally well be used for address converters, which convert all the IP addresses in the first network to a single second network IP address and for address converters, which convert the first network IP addresses separately to second network IP addresses. The last instance is significant when network separation takes place not because of a shortage of address fields but due to security considerations.

As already mentioned with respect to FIG. 1, the network elements NE1, NE2 can be terminals, media gateways, access concentrators, multimedia servers or any other network elements in an IP network. In the case of terminals, these may for example be voice-over-IP VoIP terminals or terminals for IP-based video conferences.

The UDP/TCP port numbers were not taken into account for the embodiment in FIG. 2, to keep the diagram as simple as possible. However these port numbers are address components when UDP or TCP is used. It is also obvious that instead of an address converter, which generates relationships of the type IP<->IP′ one of the commonly used address converters IP:Port<->IP′:Port′ can be used, with which the address converter has only a few or a single address IP′ for the global network.

Session Initiation Protocol SIP, Bearer Independent Call Control BICC, ITU-T H.323, ITU-T H.248 or Media Gateway Control Protocol MGCP can be used as protocols for connection control.

What is claimed is:

1. A method for address conversion for a user data connection controlled via a signaling connection between a first communication network, which has addresses which are valid within the first network, and a second communication network, comprising:
initiating a connection request by a first network element located in the first communication network, the first network element having a first address, with the connection request communicating with a second network element accessible via the second communication network, the second network element having a second address, the connection request first being routed to a control element in the first communication network located at a point of transition between the first and second communication networks, the control element having a third address in the first communication network and a fourth address in the second communication network; and
sending a message with the first address as the source address and the fourth address as the destination address is sent, by the control element, via a fourth network element, which switches user data, to determine a valid address conversion relationship between the first and second communication networks for the user data connection of the first network element routed via the fourth network element.

2. The method according to claim 1, wherein an address determined by means of the determined address conversion relationship, representing the first network element in the second communication network is used as the source address for the connection request forwarded by the control element instead of the first address.

3. The method according to claim 1, wherein the address conversion relationship in the fourth network element is defined statically and is modified administratively or automatically on the basis of predefined criteria.

4. The method according to claim 1, wherein the address conversion relationship in the fourth network element is dynamic and is initialized by the message sent by the control element.

5. The method according to claim 1, wherein the first and second communication networks are packet networks.

6. The method according to claim 2, wherein the fourth network element is a Network Address Translation NAT or Network Port Address Translation NPAT router.

7. A method for address conversion for a user data connection controlled via a signaling connection, with the user data connection made up of a number of data channels, comprising:
determining a base address conversion for a first data channel between the first and a second communication network, for a network element requesting a connection and assigned to the first communication network; and
forming all other data channels by a predefined algorithm from the base address conversion and modified by an address converter.

8. The method according to claim 7, wherein a base address representing the network element requesting the connection in the second communication network determined from the base address conversion is used in a forwarded connection request.

9. The method according to claim 7, wherein the specified algorithm is used by a recipient to determine the addresses of the other data channels from the transferred base address of the first of the data channels.

10. The method according to claim 7, wherein the address conversion in the address converter is dynamic.

11. The method according to claim 7, wherein the base address conversion is obtained by
initiating a connection request by a first network element located in the first communication network, the first network element having a first address, with the connection request communicating with a second network element accessible via the second communication network, the second network element having a second address, the connection request first being routed to a control element in the first communication network located at a point of transition between the first and second communication networks, the control element having a third address in the first communication network and a fourth address in the second communication network; and
sending a message with the first address as the source address and the fourth address as the destination address is sent, by the control element, via a fourth network element, which switches user data, to determine a valid address conversion relationship between the first and second communication networks for the user data connection of the first network element routed via the fourth network element.

12. The method according to claim 7, wherein the address converter is a Network Address Translation NAT or Network Port Address Translation NPAT router.

13. The method according to claim 1, wherein the first and second communication networks are packet networks, in which the internet protocol IP is used, and the addresses are made up of IP addresses and port numbers of the User Datagram Protocol UDP or the Transmission Control Protocol TCP.

14. The method according to claim 1, wherein one of the following protocols is used for the signaling connection (SV): Session Initiation Protocol SIP, Bearer Independent Call Control BICC, ITU-T H.323, ITU-T H.248 or Media Gateway Control Protocol MGCP.

15. A control element for communication networks, which is located at a point of transition between a first and a second communication network, with the first network having addresses which are valid within the first network, and with the control element having both a third address in the first network and a fourth address in the second network, comprising:
receiving devices for receiving a connection request from a first communication network element located in the first network, which first network element has a first address, with the connection request communicating with a second network element accessible via the second network to which second network element a second address is assigned; and
sending with devices for sending a message with the first address as the source address and the fourth address as the destination address via a fourth network element, which switches user data, to determine a valid address conversion relationship between the first and second communication networks for a user data connection of the first network element routed via the fourth network element.

16. The control element according to claim 15, further comprising address devices to determine an address representing the first network element in the second communication network from the determined address conversion relationship and connection devices to forward the connection request with the determined address representing the first network element in the second communication network instead of the first address as the source address.

17. The control element according to claim 15, wherein the control element controls the setting up of the connection according to one of the following protocols: Session Initiation Protocol SIP, Bearer Independent Call Control BICC, ITU-T H.323, ITU-T H.248 or Media Gateway Control Protocol MGCP.

18. An address converter for communication networks, which is located at a point of transition between a first and a second communication network, with the first network having addresses which are valid within the first network, comprising:
receiving devices to receive a message, which explicitly or implicitly includes information about the number of data channels to be reserved;
determining devices to determine a base address conversion and further address conversions based on the base address conversion, with a total number of address conversions being based on the number of data channels to be reserved.

19. The address converter according to claim 18, further comprising limiting devices to limit the time period, during which the determined address conversions are valid and/or devices for the selective release of reserved address conversions in response to an absence of data traffic during a time period.

20. The address converter according to claim 18, wherein the address converter switches Real Time Protocol RTP connections in conjunction with the Real Time Control Protocol RTCP.

21. The address converter according to claim 18, further comprising a control element comprising:
receiving devices for receiving a connection request from a first communication network element located in the first network, which first network element has a first address, with the connection request communicating with a second network element accessible via the second network to which second network element a second address is assigned; and
sending with devices for sending a message with the first address as the source address and the fourth address as the destination address via a fourth network element, which switches user data, to determine a valid address conversion relationship between the first and second communication networks for a user data connection of the first network element routed via the fourth network element.

22. The method according to claim 7, wherein the first and second communication networks are packet networks, in which the internet protocol IP is used, and the addresses are made up of IP addresses and port numbers of the User Datagram Protocol UDP or the Transmission Control Protocol TCP.

23. The method according to claim 7, wherein one of the following protocols is used for the signaling connection (SV): Session Initiation Protocol SIP, Bearer Independent Call Control BICC, ITU-T H.323, ITU-T H.248 or Media Gateway Control Protocol MGCP.
